(19) United States
(12) Patent Application Publication
(10) Pub. No.: US 2019/0039523 A1
(43) Pub. Date: Feb. 7, 2019

(54) PARTITIONING DEVICE FOR A CARGO COMPARTMENT OF A MOTOR VEHICLE

(71) Applicant: FORD GLOBAL TECHNOLOGIES, LLC, Dearborn, MI (US)

(72) Inventors: Hubert Szawarski, Waterford, MI (US); Jialiang Le, Canton, MI (US); Manoharprasad K. Rao, Novi, MI (US)

(21) Appl. No.: 15/670,390

(22) Filed: Aug. 7, 2017

(51) Int. Cl. B60R 5/04; B60R 7/02; B60R 7/08

(52) U.S. Cl. CPC B60R 5/045; B60R 7/08; B60R 7/02

(57) ABSTRACT

A partitioning device includes a first panel, a second panel and a slider lock mechanism. The first panel includes a first hinge that pivots and slides along a first guide track. The second panel includes a second hinge that pivots and slides along a second guide track. The slider lock mechanism is displaceable between an unlocked position and a locked position wherein the two panels are secured together.

### TECHNICAL FIELD

This document relates generally to the motor vehicle equipment field and, more particularly, to a new and improved partitioning device for a cargo compartment of a motor vehicle. The partitioning device is particularly beneficial when used to partition the trunk of a motor vehicle where that trunk has a forward end that is difficult to reach when the trunk lid is opened.

### BACKGROUND

The trunk area in many motor vehicles today may be as long as four feet or more from the rear wall at the trunk lid sill to the forward wall behind the rear seat and under the package tray of the motor vehicle. It is difficult to reach small items such as grocery bags or the like that might roll forward during motor vehicle operation toward the front wall of such a trunk compartment. This is particularly true since most trunk openings are relatively narrow in the vertical direction.

This document relates to a new and improved partitioning device for a cargo compartment of a motor vehicle. The partitioning device is particularly useful for dividing a trunk storage area into a forward section between the partitioning device and the front wall of the trunk storage compartment and a rearward section between the partitioning device and the rear wall of the trunk storage compartment. Advantageously, the partitioning device may be conveniently stored along the side walls of the cargo compartment when not in use. In this stowed position the partitioning device does not interfere in any way with the full use of the entire storage space of the storage compartment. In contrast, when deployed, small items may be retained by the partitioning device in the rearward section of the storage compartment adjacent the rear wall thereof where they may be easily accessed through the trunk opening.

### SUMMARY

In accordance with the purposes and benefits described herein, a new and improved partitioning device is provided for a cargo compartment of a motor vehicle. That partitioning device comprises a first panel including a first hinge at a first proximal end. The partitioning device also includes a second panel including a second hinge at a second proximal end. Further, the partitioning device includes a slider lock mechanism displaceable between an unlocked position and a locked position.

The partitioning device may further include a first guide track which may be provided along a first sidewall of the storage compartment. The first hinge pivots in and slides along that first guide track. The partitioning device may also include a second guide track provided on a second sidewall of the storage compartment opposite the first sidewall. The second hinge pivots in and slides along the second guide track. Advantageously, the two hinges allow the respective first panel and second panel to be displaced between a stowed position, extending along the side walls of the storage compartment, and a deployed position, extending across the storage compartment, in a manner that will be described in greater detail below.

In addition, the partitioning device may further include a first stop on the first panel adjacent the first hinge. Similarly, a second stop may be provided on the second panel adjacent the second hinge. The first stop and the second stop allow one to lock the first panel and the second panel in a selected position along the respective first and second guide tracks when the first and second panels are deployed for use.

In one possible embodiment the first stop includes a first set of projecting tabs outboard the first hinge. Similarly, the second stop includes a second set of projecting tabs outboard the second hinge. Those tabs engage the respective, adjacent sidewalls when the first and second panels are deployed.

The slider mechanism may include a locking panel having a first guide. The first panel may include a closed guideway and the first guide may slide along that closed guideway as the slider lock mechanism is displaced between the unlocked position and the locked position.

In addition, the locking panel may include a channel. The locking panel may nest over the first panel when the slider lock mechanism is in the unlocked position. The locking panel may nest over at least a portion of the first panel and the second panel when the slider lock mechanism is in the locked position thereby locking the first and second panels together. The locking panel may also include a second guide.

In one possible embodiment, the second panel includes a latch receiver and the second guide engages in the latch receiver when the slider lock mechanism is in the locked position.

In a second possible embodiment, the second panel includes an open-ended guideway. The second guide is received in the open-ended guideway when the slider lock mechanism is in the locked position. Further, in the second embodiment the first panel includes a first guide receiver at a first end of the closed guideway and a second guide receiver at a second end of the closed guideway. The first guide is received in the first guide receiver when the slider lock mechanism is in the unlocked position. In contrast, the first guide is received in the second guide receiver when the slider lock mechanism is in the locked position.

In the following description, there are shown and described several preferred embodiments of the partitioning device. As it should be realized, the partitioning device is capable of other, different embodiments and its several details are capable of modification in various, obvious aspects all without departing from the partitioning device as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the partitioning device and together with the description serve to explain certain principles thereof.

FIG. 1 is a schematic perspective view of the partitioning device utilized in a trunk of a motor vehicle and illustrating that device in the stowed position with the panels of that device stowed along the sidewalls of the trunk storage compartment.

FIG. 2 is a schematic perspective view similar to FIG. 1 but illustrating the partitioning device in the partially deployed position.

FIG. 3 is a schematic perspective view similar to FIGS. 1 and 2 but further illustrating the partitioning device in a fully deployed and locked position partitioning the trunk storage compartment into a forward section between the front wall of the storage compartment and the partitioning device and a rearward storage section between the rear wall of the trunk compartment and the partitioning device.

FIG. 4a is a detailed end elevational view of the first panel of the partitioning device illustrating the first hinge that pivots in and slides along the first guide track.

FIG. 4b is a detailed end elevational view of the second panel of the partitioning device illustrating the second hinge that pivots and slides along the second guide track.

FIG. 5a is a top plan view of the first panel engaged in the first guide track.

FIG. 5b is a top plan view of the second panel engaged in the second guide track.

FIG. 6 is an exploded perspective view of a first possible embodiment of a slider lock mechanism for the partitioning device.

FIG. 6a is a perspective view illustrating the first possible embodiment of the slider lock mechanism illustrated in FIG. 6 in the unlocked position.

FIG. 6b is a perspective view illustrating the first possible embodiment of the slide lock mechanism illustrated in FIG. 6 in the locked position.

FIG. 7 is an exploded perspective view of a second possible embodiment of a slider lock mechanism for the partitioning device.

FIG. 7a is a detailed perspective view illustrating that second embodiment of slider lock mechanism in the unlocked position.

FIG. 7b is a detailed perspective view illustrating that second embodiment of the slider lock mechanism in the locked position.

Reference will now be made in detail to the present preferred embodiments of the partitioning device, examples of which are illustrated in the accompanying drawing figures.

### DETAILED DESCRIPTION

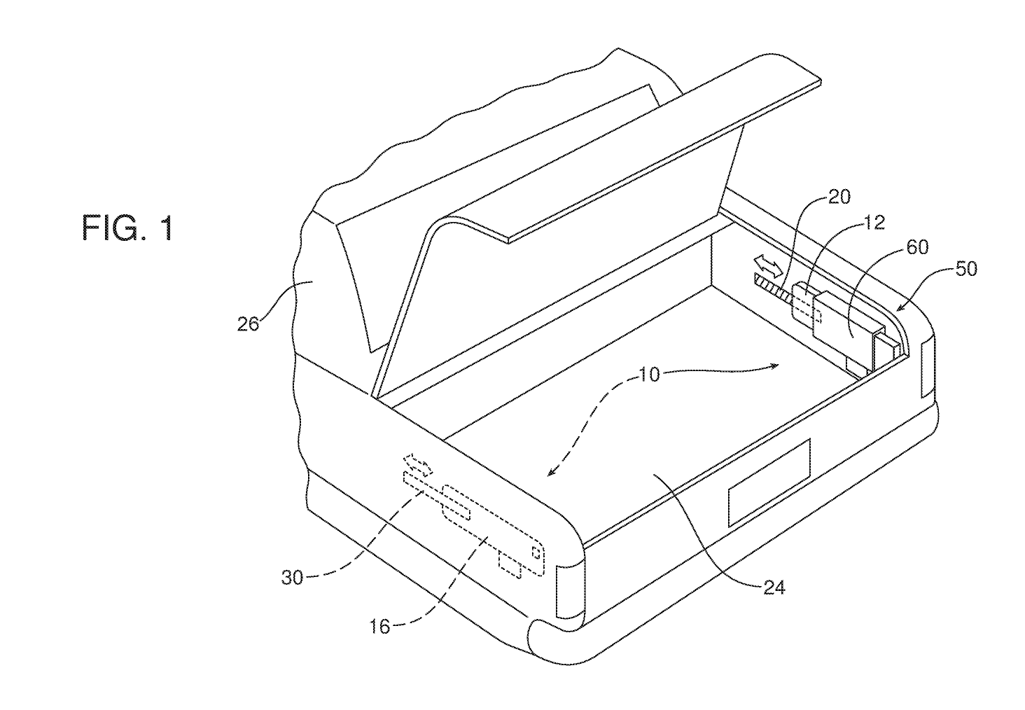

Reference is now made to FIGS. 1-3 illustrating the partitioning device 10 in respective stowed, partially deployed and fully deployed positions. As illustrated in FIGS. 1-3, 4a and 5a, the partitioning device 10 comprises a first panel 12 including a first hinge 14 at a first proximal end. As illustrated in FIGS. 1-3, 4b and 5b, the partitioning device 10 also includes a second panel 16 having a second hinge 18 at a second proximal end.

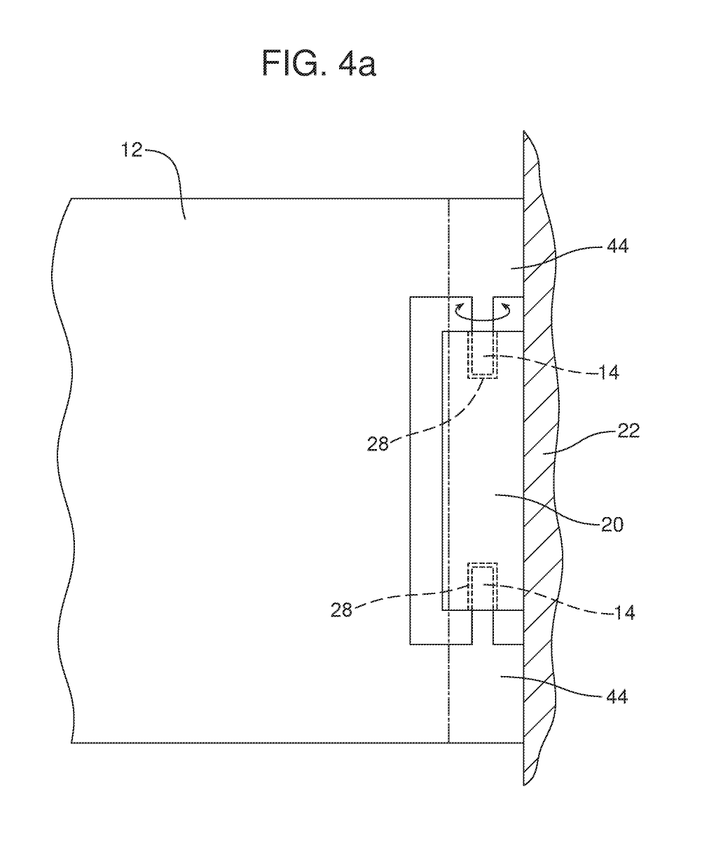

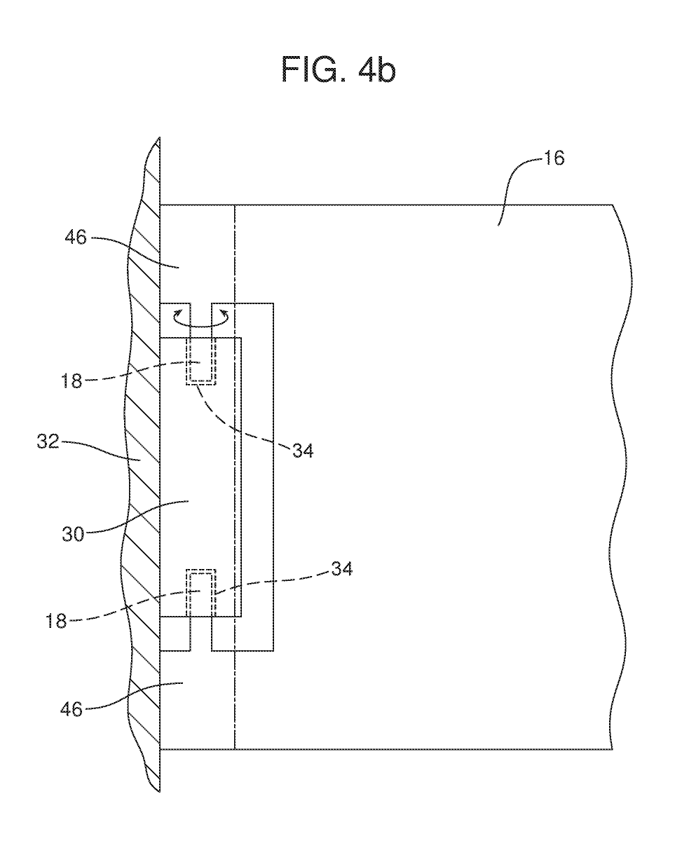

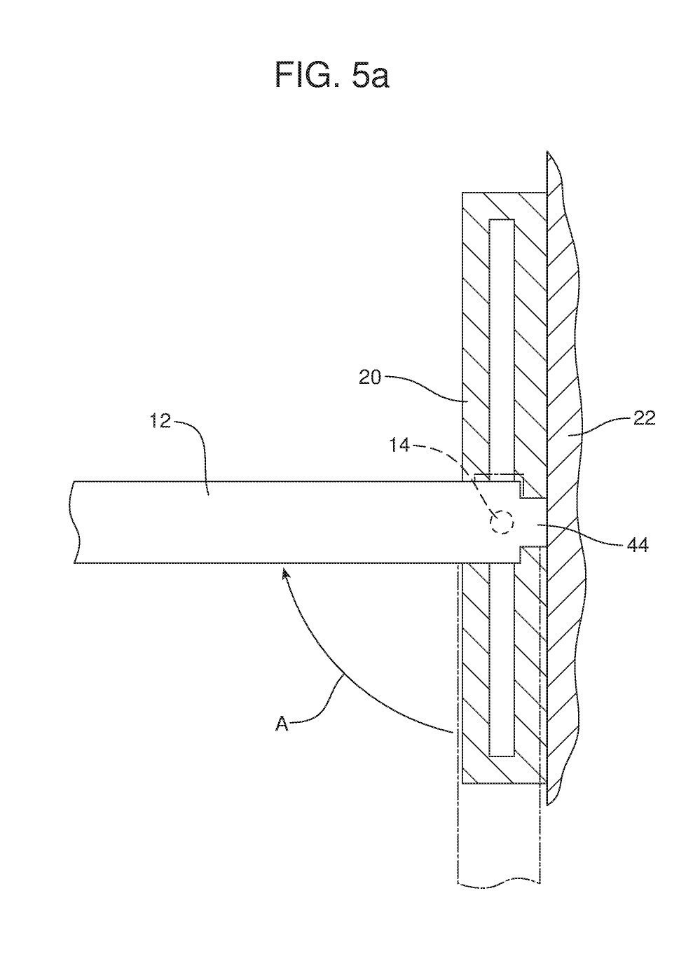

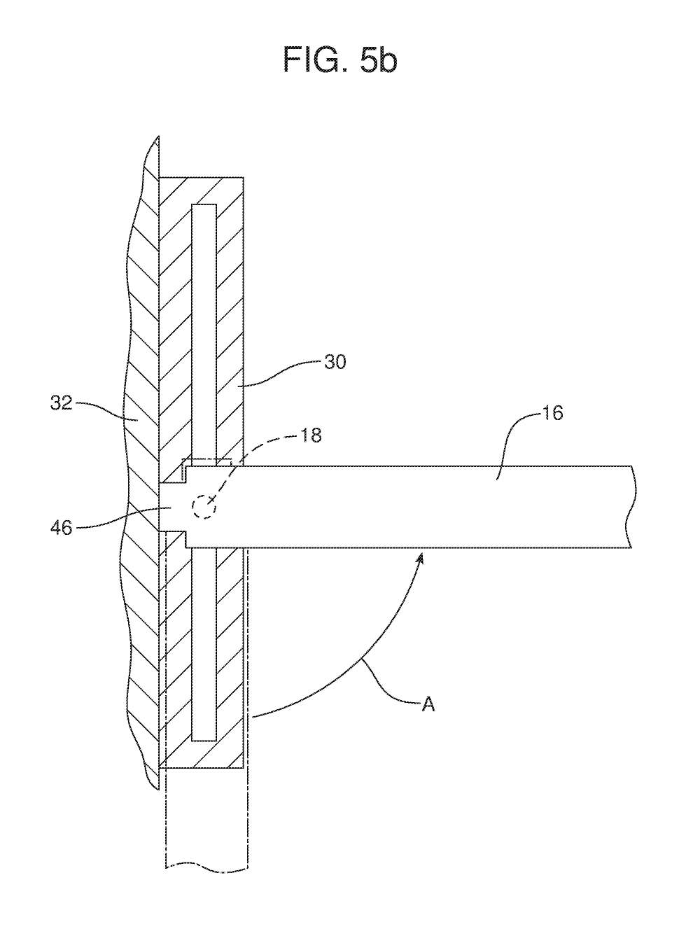

The partitioning device 10 also includes a first guide track 20 carried on or secured to a first sidewall 22 of a trunk storage compartment 24 of a motor vehicle 26. As should be appreciated, the first hinge 14 pivots in and slides along the first guide track 20 thereby allowing one to selectively adjust the longitudinal position of the first panel 12 of the partitioning device 10 within the trunk storage compartment 24. As shown in FIGS. 4a and 5a, the first hinge 14 comprises opposed pins received in opposed channels 28 of the first guide track 20.

In addition, the partitioning device 10 includes a second guide track 30 carried on a second sidewall 32 of the trunk storage compartment 24 directly opposite the first sidewall 22 and the first guide track 20. As should be appreciated, the second hinge 18 pivots in and slides along the second guide track 30 to allow one to adjust the longitudinal position of the second panel 16 of the partitioning device 10 within the trunk storage compartment 24. As shown in FIGS. 4b and 5b, the second hinge 18 comprises opposed pins received in opposed channels 34 of the second guide track 30.

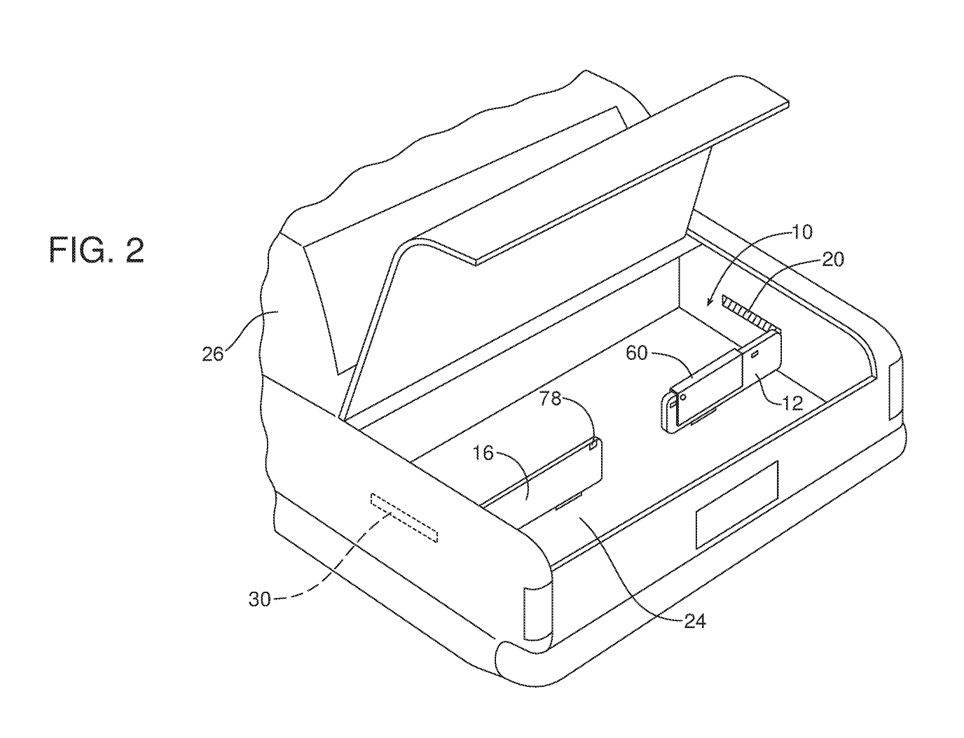

As best illustrated in FIGS. 4a and 5a, the first panel 12 includes a first stop 44 adjacent the first hinge 14. In the illustrated embodiment, the first stop 44 comprises a first set of projecting tabs outboard of the first hinge 14. When the first panel 12 is displaced from the first stowed position illustrated in FIG. 1 and in phantom line in FIG. 5a to the fully deployed position illustrated in FIG. 2 and the full line position illustrated in FIG. 5a (note action arrow A), the first set of projecting tabs/first stop 44 engage with the first sidewall 22 thereby effectively holding the first panel 12 in the selected longitudinal position along the first guide track 20.

As illustrated in FIGS. 4b and 5b, the second panel 16 includes a second stop 46 adjacent the second hinge 18. In the illustrated embodiment, the second stop 46 comprises a second set of projecting tabs outboard the second hinge 18. The second set of projecting tabs/second stop 46 engage the second sidewall 32 and effectively hold the second panel 16 in the selected longitudinal position when the second panel is fully deployed as illustrated in FIG. 2 and in full line in FIG. 5b.

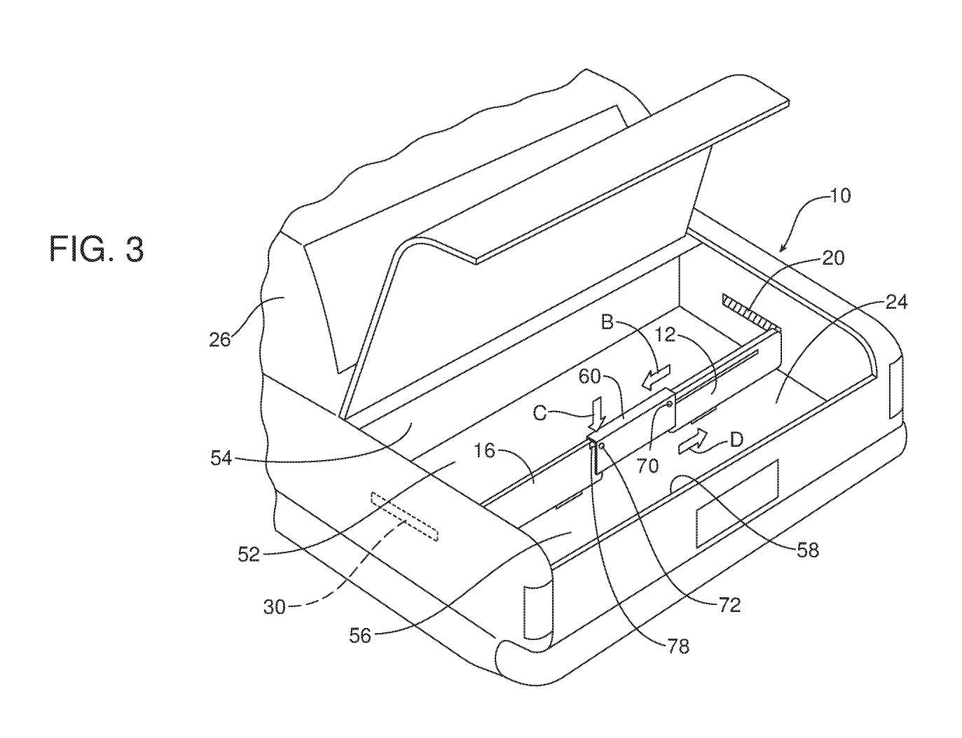

The partitioning device 10 also includes a slider lock mechanism, generally designated by reference numeral 50. As should be appreciated from reviewing FIGS. 1-3, the slider lock mechanism 50 is displaceable between an unlocked position illustrated in FIGS. 1 and 2 and a locked position illustrated in FIG. 3. In the locked position, the slider lock mechanism 50 securely connects the first distal end of the first panel 12 to the second distal end of the second panel 16 so that the partitioning device 10 extends completely across the trunk storage compartment 24 thereby partitioning the trunk storage compartment into a forward section 52 between the partitioning device 10 and the forward wall 54 of the trunk storage compartment and a rearward section 56 between the partitioning device and the rear wall 58 of the trunk storage compartment.

It should be appreciated that the slider lock mechanism 50 may assume a number of different configurations. In the embodiment illustrated in FIGS. 1-3 and 6-6b, the slider lock mechanism 50 includes a locking panel 60 having a U-shaped cross section defining a channel 62. The locking panel 60 may have a first leg 64, a second leg 66 and an intermediate connecting section 68. The locking panel 60 may be made as a single unitary structure if desired.

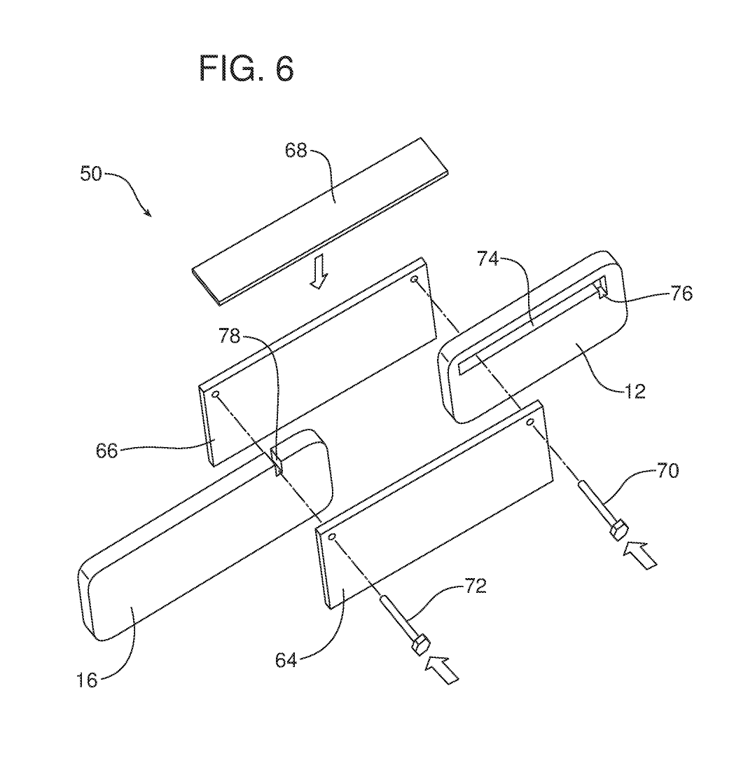

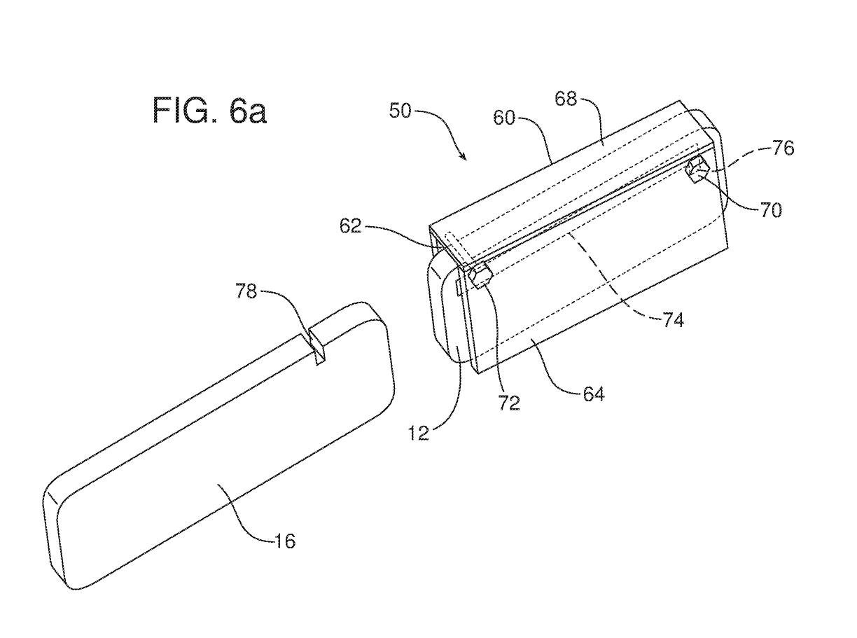

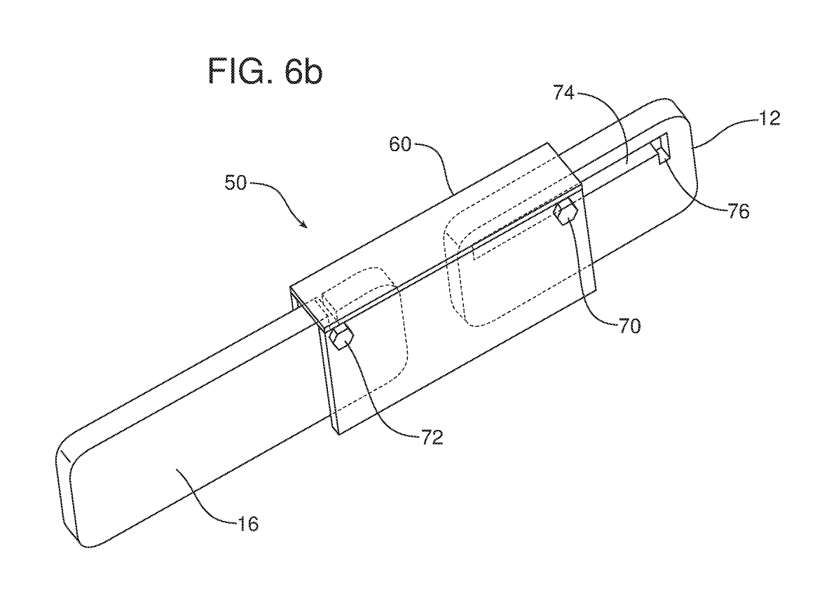

As further illustrated in FIGS. 6-6b, the locking panel 60 includes a first guide 70 and a second guide 72 in the form of guide pins. The first guide 70 and the second guide 72 are provided in apertures at opposite ends of the locking panel 60 and extend from the first leg 64 to the second leg 66 so as to span across the channel 62.

As further illustrated in FIGS. 6-6b, the first panel 12 includes a closed guideway 74 having a first notch or first guide receiver 76 at one end thereof. A second notch or second guide receiver 78 is provided in the upper edge of the second panel 16. When the partitioning device 10 is unlocked and in the stowed position, the locking panel 60 nests over the first panel 12 with the first guide 70 resting in the first guide receiver 76 at the end of the closed guideway 74. See FIG. 6a. In contrast, when the partitioning device 10 is in the fully deployed and locked position, the first panel 12 and the second panel 16 are deployed in a line across the trunk storage compartment 24 as illustrated in FIG. 2 and the locking panel 60 slides in the direction of action arrow B (see FIG. 3) with the first guide 70 sliding through the closed guideway 74 until the second guide 72 is aligned with and drops down into the second guide receiver 78 on the second panel 16 (note action arrow C). When in this locked position, it should be appreciated that the locking panel 60 nests partially over both the first panel 12 and the second panel 16 fully closing the gap between the panels and forming a continuous partition spanning across the trunk storage compartment 24 between the first sidewall 22 and the second sidewall 32. Here it should be appreciated that the first set of projecting tabs/first stop 44 at the end of the first panel 12 engages the first sidewall 22 while the second set of projecting tabs/second stop 46 at the end of the second panel engages the second sidewall 32 to hold the partitioning device 10 in the selected longitudinal position along the guide tracks 20 and 30 in the trunk storage compartment 24.

One may unlock the slider lock mechanism 50 illustrated in FIGS. 6-6b by pulling up on locking panel 60 adjacent the second guide 72, thereby releasing the second guide from the second guide receiver 78 and allowing one to again slide the locking panel 60 in the direction of action arrow D until it is once again fully nested on the first panel 12 with the first guide 70 engaged in the first guide receiver 76. The first panel 12 and the second panel 16 may then be pivoted about the respective first hinge 14 and second hinge 18 until the panels are in the stowed position along the sidewalls 22, 32 of the trunk storage compartment 24. Hook and loop fasteners or other means of a type known in the art (not shown) may be utilized to hold the free ends of the panels 12, 16 in the stowed position along the sidewalls 22, 32 if desired.

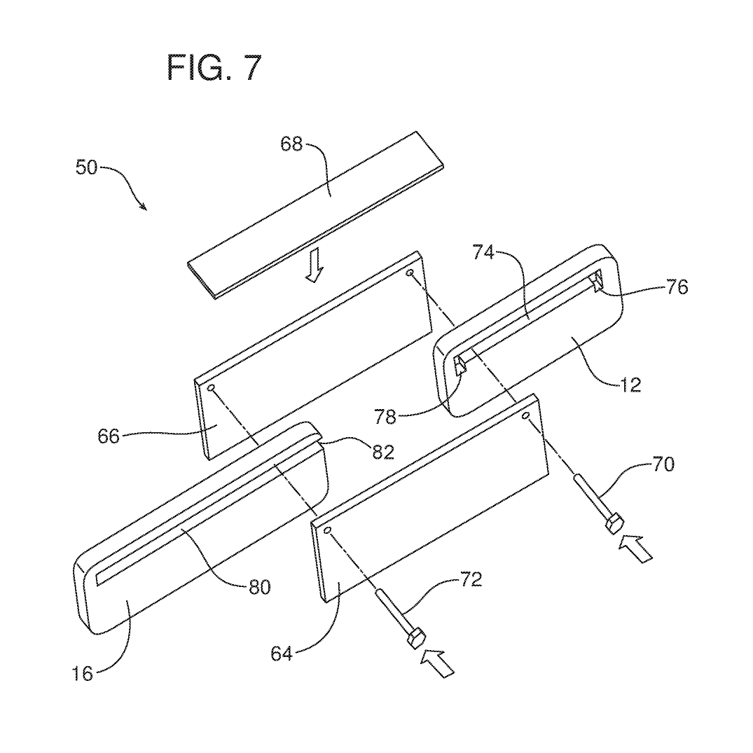

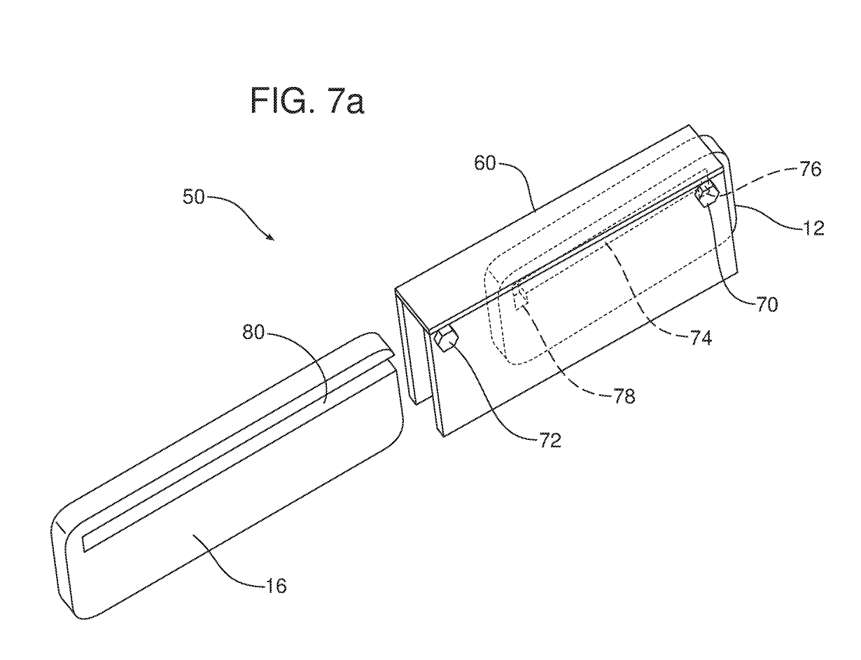

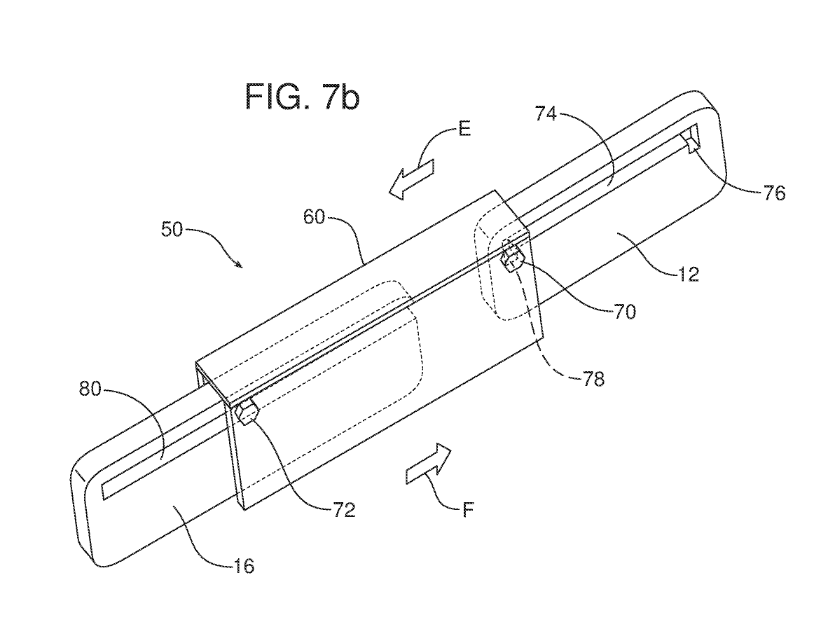

Reference is now made to FIGS. 7-7b illustrating a second possible embodiment of the slider lock mechanism 50. In this embodiment, the locking panel 60 is of identical construction to the locking panel illustrated in the previous embodiment of FIGS. 6-6b. In the interest of brevity, that construction will not be described in detail again and the same reference numbers are used to identify identical features.

In the embodiment illustrated in FIGS. 7-7b, the closed guideway 74 includes a first guide receiver 76 at a first end thereof and a second guide receiver 78 at the second end thereof. The second panel 16 includes an open-ended guideway 80. When the slider lock mechanism 50 illustrated in FIG. 7a is in the unlocked position, the locking panel 60 is fully nested over the first panel 12 and the first guide 70 is received and engaged in the first guide receiver 76. When one wishes to displace the slider lock mechanism 50 to the locked position, one raises the first guide end of the locking panel 60 to unseat the first guide 70 from the first guide receiver 76. Next one slides the locking panel 60 in the direction of action arrow E (See FIG. 7b) sliding the first guide 70 through the closed guideway 74 until the second guide 72 passes through the entry 82 into the open-ended guideway 80.

The operator then continues to slide the locking panel 60 in the direction of action arrow E until the first guide 70 drops down into the second guide receiver 78 with the locking panel 60 partially nested over both of the first panel 12 and second panel 16 (i.e. a part of the first panel and a part of the second panel are received in the channel 62 of the locking panel 60). Thus, in this configuration, the first panel 12 is locked with the second panel 16 and the locking panel 60 bridges the gap between the first and second panels creating a substantially continuous partition dividing the trunk storage compartment 24 into a forward section 52 and a rearward section 56.

When one wishes to unlock the slider lock mechanism 50 of the FIGS. 7-7b embodiment, one first lifts the locking panel 60 at the first guide end in order to unseat the first guide 70 from the second guide receiver 78. Then one slides the locking panel 60 in the direction of action arrow F with the second guide sliding along the open-ended guideway 80 and the first guide 70 sliding along the closed guideway 74. Once one slides the locking panel 60 fully to the right in the drawing figure, the second guide 72 exits the open end of the open-ended guideway 80 and the first guide 70 drops down and engages in the first guide receiver 76 thereby holding the locking panel 60 in the stowed position fully nested over the first panel 12. In this position the locking panel 60 is free of the second panel 16 and the first panel 12 and second panel 16 may be pivoted about the respective hinges 14, 18 from the deployed position illustrated in FIG. 2 to the stowed position illustrated in FIG. 1.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A partitioning device, comprising:
a first panel including a first hinge at a first proximal end;
a second panel including a second hinge at a second proximal end; and
a slider lock mechanism displaceable between an unlocked position and a locked position.

2. The partitioning device of claim 1, further including a first guide track, said first hinge pivoting and sliding along said first guide track whereby said first panel is displaced between a first stowed position and a first deployed position.

3. The partitioning device of claim 2, further including a second guide track, said second hinge pivoting and sliding along said second guide track whereby said second panel is displaced between a second stowed position and a second deployed position.

4. The partitioning device of claim 3, further including a first stop on said first panel adjacent said first hinge.

5. The partitioning device of claim 4, further including a second stop on said second panel adjacent said second hinge.

6. The partitioning device of claim 5, wherein said first stop includes a first set of projecting tabs outboard said first hinge.

7. The partitioning device of claim 6, wherein said second stop includes a second set of projecting tabs outboard said second hinge.

8. The partitioning device of claim 7, wherein said slide lock mechanism includes a locking panel having a first guide.

9. The partitioning device of claim 8, wherein said first panel includes a closed guideway, said first guide sliding along said closed guideway as said slider lock mechanism is displaced between said unlocked position and said locked position.

10. The partitioning device of claim 9, wherein said locking panel includes a channel, said locking panel nesting over said first panel when said slider lock mechanism is in said unlocked position and said locking panel nesting over at least a portion of said first panel and said second panel when said slider lock mechanism is in said locked position.

11. The partitioning device of claim 10, wherein said locking panel includes a second guide.

12. The partitioning device of claim 11, wherein said second panel includes a latch receiver, said second guide engaging in said latch receiver when said slider lock mechanism is in said locked position.

13. The partitioning device of claim 11, wherein said second panel includes an open-ended guideway, said second guide being received in said open-ended guideway when said slide lock mechanism is in said locked position.

14. The partitioning device of claim 13, wherein said first panel includes a first guide receiver at a first end of said closed guideway and a second guide receiver at a second end of said closed guideway.

15. The partitioning device of claim 14, wherein said first guide is received in said first guide receiver when said slider lock mechanism is in said unlocked position.

16. The partitioning device of claim 15, wherein said first guide is received in said second guide receiver when said slider lock mechanism is in said locked position.
